(19) United States
(12) Patent Application Publication
(10) Pub. No.: US 2013/0242179 A1
(43) Pub. Date: Sep. 19, 2013

(54) VIDEO DEVICE AND ADJUSTING MECHANISM THEREOF

(71) Applicant: VIVOTEK INC., New Taipei City (TW)

(72) Inventor: Shang-Yu HUANG, New Taipei City (TW)

(73) Assignee: VIVOTEK INC., New Taipei City (TW)

(21) Appl. No.: 13/831,079

(22) Filed: Mar. 14, 2013

(30) Foreign Application Priority Data
Mar. 15, 2012 (TW) 101204759

(51) Int. Cl. H04N 5/225

(52) U.S. Cl. CPC H04N 5/2251
USPC 348/373

(57) ABSTRACT

An adjusting mechanism, applicable for a video device, includes a fixing bracket, an adjusting component, a linking component and a rotating bracket. The adjusting component is disposed on a side of the fixing bracket. The linking component is engaged with the adjusting component. The rotating bracket is connected to the linking component and is pivoted to the fixing bracket. When the adjusting component is rotated by an external force, the linking component drives the rotating bracket to pivot relative to the fixing bracket.

### CROSS-REFERENCE TO RELATED APPLICATIONS

This non-provisional application claims priority under 35 U.S.C. §119(a) on Patent Application No(s). 101204759 filed in Taiwan, R.O.C. on Mar. 15, 2012, the entire contents of which are hereby incorporated by reference.

### TECHNICAL FIELD

The disclosure relates to a video device and an adjusting mechanism thereof, and more particularly to a fixed video device and an adjusting mechanism thereof.

### BACKGROUND

No matter at homes, enterprises, governments or public places, a surveillance camera plays important role on human security and asset protection. Typically, the surveillance camera comprises a video device for monitoring the condition of a certain monitored environment such that unexpected invasions and occurrences of special circumstances may be detected, and therefore user may be informed immediately so as to handle the events. The conventional surveillance camera has two types which are fixed surveillance camera and rotary surveillance camera.

In the conventional rotary surveillance camera, a video device may rotate automatically according to original design and setting, or according to the remote control by users. The video device may be driven to rotate to a desired field of view by a driving mechanism (such as a linear motor).

The other kind of surveillance camera is the fixed surveillance camera. As the name implies, the fixed surveillance camera shoots or monitors at a certain angle. Moreover, for being hidden and anti-explosion, the conventional fixed surveillance camera is designed to be a dome shape and is located on a ceiling. Furthermore, a dome-shape casing covers the video device in order to prevent the video device from exposure, which causes damage.

Generally speaking, when the shooting angle of the lens module of the fixed surveillance camera needs to be adjusted, the general approach is to loose a side screw so as to loose the video device, than the shooting angle of the lens module may be adjusted by hands. Another conventional approach is to directly adjust the shooting angle by hands.

However, in these approaches for adjusting the shooting angle of the lens module by hands, when the shooting angle of the video device is adjusted, a fixing component of the video device may cause the lens module to shake or lose focus because the fixing and clamping of the fixing component is weak. Moreover, the shooting angle of the lens module may easily be deviated by gravity as time goes by. When the video device is pressed by hands, the structure of the fixing component may be damaged by inappropriate force, such that the fixing component may lose the function of fixing the shooting angle of the video device, and the user may not adjust the desired shooting angle of the video device. Therefore, in the fixed surveillance camera, because the shooting angle of the video device is adjusted by hands, the fixing component may not fix the shooting angle of the video device, such that the fixed surveillance camera may not monitor the desired field of view and the maintenance cost is increased.

### SUMMARY

An embodiment of the disclosure provides an adjusting mechanism, applicable for a video device. The adjusting mechanism comprises a fixing bracket, an adjusting component, a linking component and a rotating bracket. The adjusting component is disposed on a side of the fixing bracket. The linking component is engaged with the adjusting component. The rotating bracket is connected to the linking component and is pivoted to the fixing bracket. When the adjusting component is rotated by an external force, the linking component drives the rotating bracket to pivot relative to the fixing bracket.

Another embodiment of the disclosure provides a video device comprising a lower casing, an adjusting mechanism, a video module and a top cover. The lower casing comprises a circuit board. The adjusting mechanism is disposed on the lower casing. The adjusting mechanism comprises a fixing bracket, an adjusting component, a linking component and a rotating bracket. The fixing bracket is disposed on the lower casing. The adjusting component is disposed on a side of the fixing bracket. The linking component is engaged with the adjusting component. The rotating bracket is connected to the linking component and is pivoted to the fixing bracket. When the adjusting component is rotated by an external force, the linking component drives the rotating bracket to pivot relative to the fixing bracket. The video module is disposed on the rotating bracket. The top cover is disposed on the lower casing. The top cover includes an opening.

### BRIEF DESCRIPTION OF THE DRAWINGS

The disclosure will become more fully understood from the detailed description given herein below for illustration only, and thus does not limit the disclosure, wherein:

FIG. 1 is an exploded view of an adjusting mechanism according to an embodiment of the disclosure;

FIG. 2 is a first side view of the adjusting mechanism according to an embodiment of the disclosure;

FIG. 3 is a second side view of the adjusting mechanism according to an embodiment of the disclosure; and

FIG. 4 is an exploded view of a video device according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure provides an adjusting mechanism applicable for fixing a video module. By means of rotating the adjusting mechanism, the video module is driven to rotate (namely, spin) accordingly.

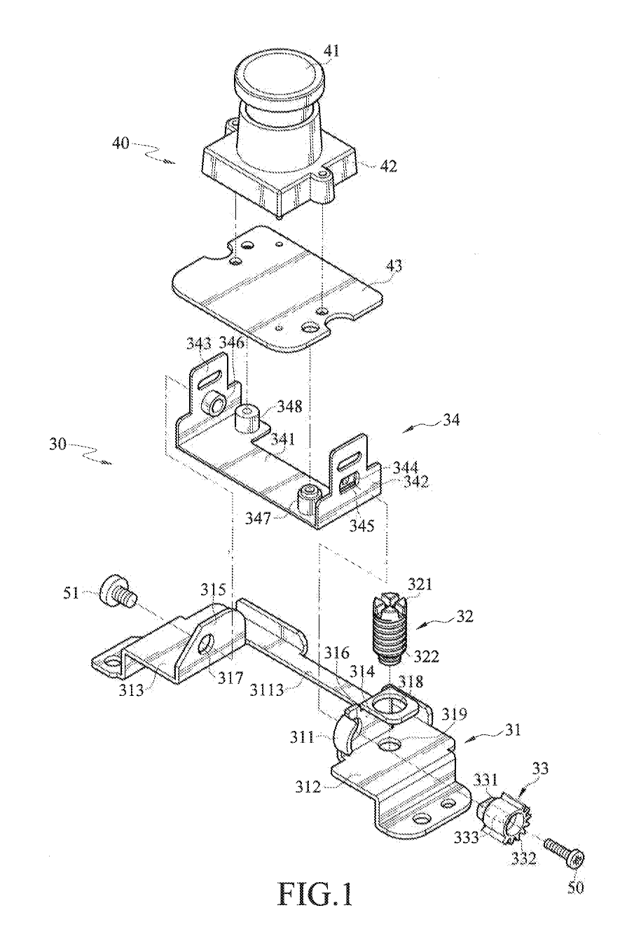

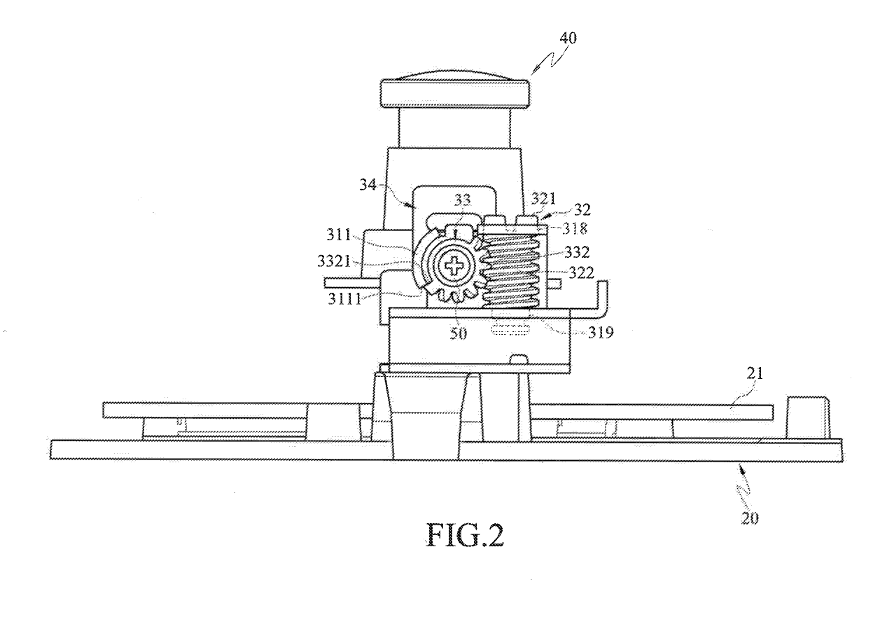

The following describes an adjusting mechanism according to an embodiment of the disclosure. Please refer to FIGS. 1 and 2, FIG. 1 is an exploded view of an adjusting mechanism according to an embodiment of the disclosure, and FIG. 2 is a first side view of the adjusting mechanism according to an embodiment of the disclosure.

The adjusting mechanism 30 comprises a fixing bracket 31, an adjusting component 32, a linking component 33 and a rotating bracket 34. The fixing bracket 31 is adapted for being fixed on a substrate (not shown). The fixing bracket 31 includes a cross plate 3113, two side plates 312 and 313, a side wall 314 and a side wall 315. The cross plate 3113 is connected to the side plates 312 and 313, respectively. That is to say, the side plates 312 and 313 are disposed on two opposite ends of the cross plate 3113, respectively. The side wall 314 is disposed on the side plate 312, and the side wall 315 is disposed on the side plate 313. The side wall 314 faces the side wall 315. Moreover, an accommodating room is formed between the side walls 314 and 315, and the rotating bracket 34 is disposed therein. Typically, the side wall 314 includes a first through hole 316, and the side wall 315 includes a first through hole 317. The first through holes 316 and 317 correspond to each other.

Furthermore, an attaching portion 318 is disposed on the top of the side wall 314. The side plate 312 includes a hollow hole 319, and the attaching portion 318 and the hollow hole 319 correspond to each other. Therefore, the adjusting component 32 penetrates through and is limited by the attaching portion 318 and the hollow hole 319 of the fixing bracket 31. Therefore, the adjusting component 32 only rotates (namely, spins) between the attaching portion 318 and the hollow hole 319. Moreover, the adjusting component 32 includes a rotating portion 321 and a thread portion 322. The rotating portion 321 is exposed from the attaching portion 318. In this embodiment, the rotating portion 321 is a cross-recessed area for a cross-shaped screw driver (not shown) to rotate. But the above-mentioned shape of the rotating portion 321 is not limited to the disclosure. Moreover, in other embodiments, the shape of the rotating portion 321 is a straight-line-recessed shape or other shapes according to corresponding rotating tools.

The following describes the structure of the linking component 33 of the adjusting mechanism 30. The linking component 33 includes a locking portion 331, a tooth portion 332 and a threaded hole 333. The locking portion 331 corresponds to the first through hole 316, and the threaded hole 333 penetrates through the locking portion 331 and the tooth portion 332. The tooth portion 332 is engaged with the thread portion 322 of the adjusting component 32. When the adjusting component 32 receives an external force to rotate around the side plate 312, the thread portion 322 drives the tooth portion 332 to rotate.

In this embodiment, the adjusting component 32 is a worm gear, and the linking component 33 is a spur gear, but such gears are not limited to the disclosure.

The following describes the structure of the rotating bracket 34 of the adjusting mechanism 30. The rotating bracket 34 includes a main body 341, two side walls 342 and 343 and two circular posts 347 and 348. The side walls 342 and 343 are respectively located on two opposite ends of the main body 341. The side wall 342 includes an indentation 344, and the indentation 344 corresponds to the locking portion 331. Moreover, the indentation 344 includes a second through hole 345, and the second through hole 345 corresponds to both the first through hole 316 and the threaded hole 333. In this embodiment, a first fixing component 50 is disposed in the threaded hole 333. The locking portion 331 penetrates through the first through hole 316 and is embedded in the indentation 344. The first fixing component 50 is locked in the threaded hole 333 and the second through hole 345, such that the fixing bracket 31, the linking component 33 and the rotating bracket 34 are connected with each other. When the adjusting component 32 receives an external force to rotate around the side plate 312, the thread portion 322 drives the tooth portion 332 to rotate accordingly. Next, by the locking portion 331 of the linking component 33 being embedded and sitting in the indentation 344 of the rotating bracket 34, when the linking component 33 rotates, the rotating bracket 34 rotates according at the same rotating angle. Moreover, since the fixing bracket 31 is securely disposed on the substrate, the fixing bracket 31 may not rotate according to the rotation of the rotating bracket 34. The circular posts 347 and 348 are disposed on the main body 341.

The side wall 314 of the fixing bracket 31 includes a limiting portion 311. The limiting portion 311, disposed in the vicinity of the first through hole 316 and the linking component 33, corresponds to the tooth portion 332. When the linking component 33 rotates, the limiting portion 311 is leaned against the tooth portion 332, which limits the rotating angle of the linking component 33.

In this embodiment, the side wall 343 of the rotating bracket 34 includes a second through hole 346 that is opposite to the first through hole 317 of the side wall 315. Therefore, a second fixing component 51 is disposed for penetrating through the first through hole 317 and the second through hole 346, such that the linking component 33 rotates relative to the first through hole 317.

The following describes the disposition of the video module 40. The video module 40 comprises a lens assembly 41, a lens base 42 and a fixing plate 43. The fixing plate 43 is securely locked on the circular posts 347 and 348 by a screw (not shown). The lens assembly 41 is disposed on the lens base 42, and the lens base 42 is affixed to the fixing plate 43 by another screw (not shown). By the above-mentioned disposition of the video module 40, because the video module 40 is affixed to the main body 341, when the linking component 33 and the rotating bracket 34 rotate, the video module 40 rotates with the rotation of the linking component 33 and the rotating bracket 34 accordingly.

In this embodiment, the first fixing component 50 and the second fixing component 51 are screws, respectively, but are not limited thereto.

The following describes a method for adjusting a rotating angle according to an embodiment of the disclosure. Referring to FIG. 2, the fixing bracket 31 is disposed on a lower casing 20, and a circuit board 21 is disposed on the lower casing 20. Thus, when the linking component 33 and the rotating bracket 34 rotate, the fixing bracket 31 may not rotate according to the linking component 33 and the rotating bracket 34. In this embodiment, the circuit board 21 is electrically connected to the video module 40. As it can be seen from FIG. 2, the tooth portion 332 of the threaded hole 333 is engaged with the thread portion 322 of the adjusting component 32. When the video module 40 is located at a first position, a surface 3111 of the limiting portion 311 leans against a tooth surface 3321 of the tooth portion 332. Therefore, the linking component 33 may not rotate clockwise (The direction shown in FIG. 2) by the rotation and driving of the adjusting component 32.

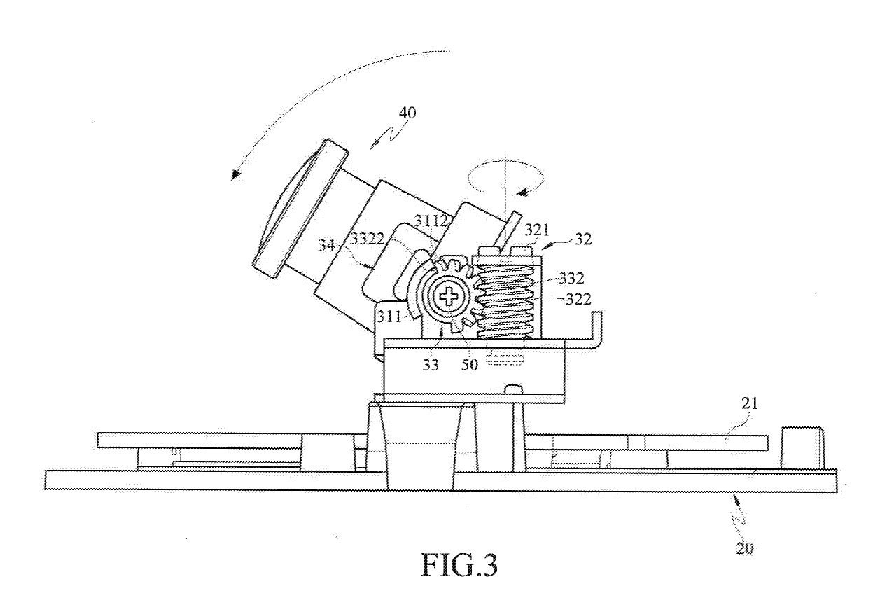

Please refer to FIG. 3, which is a second side view of the adjusting mechanism according to an embodiment of the disclosure. Next, a tool, such as a cross-shaped screw driver, is applied to rotate to turn the rotating portion 321 of the adjusting component 32 around. Since the tooth portion 332 is engaged with the thread portion 322 including a plurality of guiding layers, when the adjusting component 32 rotates a revolution, the tooth portion 332 is elevated one guiding layer of the thread portion 322 counterclockwise. Next, the adjusting component 32 rotates continuously. When the linking component 33 rotates counterclockwise around the first fixing component, the rotating bracket 34 and the video module 40, disposed on the rotating bracket 34, are driven to rotate counterclockwise around the first fixing component 50 at the same time. Therefore, the shooting angle of the video module 40 is adjusted accordingly until the surface 3112 of the limiting portion 311 limits and blocks the tooth surface 3322 of the tooth portion 332. At this time, the linking component 33 no longer rotates counterclockwise by the rotation of the adjusting component 32, and the video module 40 is at a second position. It can be seen from the FIGS. 2 and 3, in this embodiment, by means of rotating the adjusting component 32, the video module 40 may rotate from the first position to the second position.

Moreover, when the video module 40 needs to rotate from the second position to the first position, the rotating portion 321 of the adjusting component 32 spins counterclockwise, so the linking component 33, the rotating bracket 34 and the video module 40 are driven to rotate, until the video module 40 rotates to the first position. Therefore, By means of rotating the adjusting component 32, the video module 40 may rotate back and forth between the first position and the second position.

In this embodiment, rotating the adjusting component 32 by an external force comprises a method that a user holds a tool by hands, the tool is in contact with the adjusting component 32. The user applies a force to the tool so as to drive the video module 40 to rotate.

According to a video device provided in an embodiment of the disclosure, the video device is a fixed type and dome-shape video device, which is generally embedded in a ceiling and which is adapted for monitoring and illuminating to an environment. In this disclosure, the fixed type indicates that the video device may not rotate by itself automatically, and the shooting angle of the video device is adjusted by an external force.

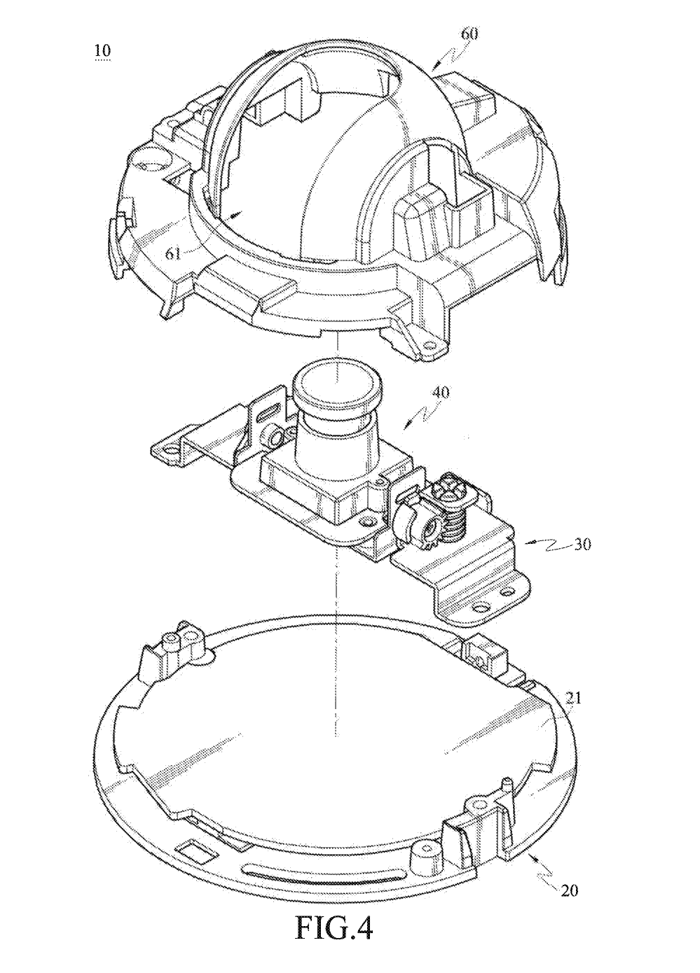

The following describes the structure of the video device. Please refer to FIG. 4, which is an exploded view of a video device according to an embodiment of the disclosure.

The video device 10 in this embodiment comprises a lower casing 20, a circuit board 21, an adjusting mechanism 30, a video module 40 and a top cover 60. The lower casing 20 is embedded or securely disposed on a ceiling (not shown), but such a disposition of the video device 10 is not limited to the disclosure. The disposition of the video device 10 is adjusted and varied according to actual requirements. The circuit board 21 is securely disposed on the lower casing 20. The circuit board 21 comprises a plurality of electronic components for recording, transmitting and compressing images. The adjusting mechanism 30 is disposed on the lower casing 20, and the circuit board 21 is disposed between the adjusting mechanism 30 and the lower casing 20. The video module 40 is securely disposed on the adjusting mechanism 30, and the video module 40 is driven to rotate by the rotation of the adjusting mechanism 30. Moreover, the video module 40 is electrically connected to the circuit board 21 by a cable (not shown). The video module 40 is adapted for capturing images outside, and the image data is converted into digital data that is transmitted to the circuit board 21 for further processing. The top cover 60 is securely disposed on the lower casing 20 and covers the lower casing 20, the circuit board 21, the adjusting mechanism 30 and the video module 40. Furthermore, the top cover 60 includes an opening 61 which corresponds to the rotatable angle of the video module 40. That is to say, the video module 40 is exposed to outside environment via the opening 61, such that the video module 40 is adapted for capturing images. Furthermore, in this embodiment, the top cover 60 is dome-shape, but is not limited thereto. In other embodiments, the shape of the top cover is square, oval or rectangular. In this embodiment, it is not necessary to dissemble the top cover 60, and the user may adjust the exposed adjusting mechanism 30 by a tool (such as a screw driver) to adjust the shooting angle of the video module 40.

According to the adjusting mechanism 30 in the embodiment of the disclosure, compared to the conventional clamping of the fixed lens, the adjusting component 32 is a worm gear, the linking component 33 is a spur gear, and the linking component 33 is embedded in the rotating bracket 34. These structures may not damage the fixed angle mechanism of the adjusting mechanism 30 by adjusting the shooting angle of the video module 40, such that the tilt and the loose of the video module 40 are avoided. Therefore, the adjusting mechanism 30 in the embodiment of the disclosure has strong and stable structure, which improves the durability of the video device.

According to the video device and the adjusting mechanism thereof, the adjusting component, the linking component and the rotating bracket are disposed therein, the adjusting component is engaged with the linking component, and the linking component is embedded and sits in the rotating bracket. When the adjusting component rotates, the linking component and the rotating bracket are driven to rotate accordingly. Therefore, in the video device and the adjusting mechanism thereof, the top cover is not necessary to be dissembled, and the shooting angle of the lens assembly can easily be adjusted by a tool, which aligns the field of view required. Consequently, the disclosure solves the problem that the shooting angle of the conventional video device has to be adjusted by hand, which easily breaks the fixing component down, such that the fixing component is easily broken and the desired shooting angle is not easily adjusted to be obtained. Therefore, in this disclosure, the maintenance cost is reduced, the shooting angle (namely, rotating angle) is easily adjusted and the durability is improved.

What is claimed is:

1. A adjusting mechanism, applicable for a video device, comprising:
a fixing bracket;
an adjusting component disposed on a side of the fixing bracket;
a linking component engaged with the adjusting component; and
a rotating bracket connected to the linking component and pivoted to the fixing bracket;
wherein, when the adjusting component is rotated by an external force, the linking component drives the rotating bracket to pivot relative to the fixing bracket.

2. The adjusting mechanism according claim 1, wherein the rotating bracket comprises a main body and a side wall, the side wall is located on an end of the main body, the side wall includes an indentation, the linking component includes a locking portion, and the locking portion of the linking component is embedded in the indentation of the rotating bracket.

3. The adjusting mechanism according claim 2, further comprising:
a first fixing component connected to the fixing bracket, the rotating bracket and the linking component, and the first fixing component also being disposed in the indentation and the locking portion.

4. The adjusting mechanism according claim 1, wherein the fixing bracket includes an limiting portion disposed in the vicinity of the linking component, and when the linking component rotates, the limiting portion limits and blocks the rotation of the linking component.

5. The adjusting mechanism according claim 1, wherein the adjusting component is a worm gear, and the linking component is a spur gear.

6. A video device, comprising:
a lower casing comprising a circuit board;
an adjusting mechanism disposed on the lower casing, and the adjusting mechanism comprising:
a fixing bracket disposed on the lower casing;
an adjusting component disposed on a side of the fixing bracket;
a linking component engaged with the adjusting component; and
a rotating bracket connected to the linking component and pivoted to the fixing bracket, wherein, when the adjusting component is rotated by an external force, the linking component drives the rotating bracket to pivot relative to the fixing bracket;
a video module disposed on the rotating bracket; and
a top cover disposed on the lower casing, and the top cover includes an opening.

7. The video device according to claim 6, wherein the rotating bracket comprises a main body and a side wall, the side wall is located on an end of the main body, the side wall includes an indentation, the linking component includes a locking portion, and the locking portion of the linking component is embedded in the indentation of the rotating bracket.

8. The video device according to claim 7, further comprising:
a first fixing component connected to the fixing bracket, the rotating bracket and the linking component, and the first fixing component is also disposed in the indentation and the locking portion.

9. The video device according to claim 6, wherein the fixing bracket includes a limiting portion disposed in the vicinity of the linking component, and when the linking component rotates, the limiting portion limits and blocks the rotation of the linking component.

10. The video device according to claim 6, wherein the adjusting component is a worm gear, and the linking component is a spur gear.
